(19) United States
(12) Patent Application Publication
(10) Pub. No.: US 2024/0166550 A1
(43) Pub. Date: May 23, 2024

(54) METHODS AND APPARATUS FOR MANUFACTURING A GLASS RIBBON

(71) Applicant: CORNING INCORPORATED, CORNING, NY (US)

(72) Inventors: James William Brown, The Villages, FL (US); Feng Gao, Corning, NY (US); Keith Mitchell Hill, Horseheads, NY (US); Elias Panides, Horseheads, NY (US); Naiyue Zhou, Leland, NC (US)

(21) Appl. No.: 18/551,099

(22) PCT Filed: May 6, 2022
(86) PCT No.: PCT/US2022/028049

§ 371 Date: Sep. 18, 2023

Related U.S. Application Data
(60) Provisional application No. 63/188,155, filed on May 13, 2021.

(51) Int. Cl. C03B 35/24; C03B 17/06; C03B 35/16

(52) U.S. Cl. CPC C03B 35/246; C03B 17/064; C03B 17/067; C03B 35/16

(57) ABSTRACT

A glass manufacturing apparatus includes a forming apparatus forming a glass ribbon. An enclosure is positioned downstream from the forming apparatus and includes a first chamber, a first end defining an inlet opening, and a second end defining an outlet opening. A first enclosure wall of the enclosure includes an enclosure wall opening defining a gas travel path from the first chamber to an exterior of the enclosure. A ribbon travel path extends through the first chamber. A first conduit extends along a first side of the enclosure and includes a second chamber. A gas opening provides fluid communication between the first chamber and the second chamber. A first gas source is in fluid communication with the second chamber. The first gas source delivers a first gas to the first chamber through the second chamber. Methods of manufacturing a glass ribbon are provided.

### CROSS-REFERENCE TO RELATED APPLICATIONS

This application claims the benefit of priority under 35 U.S.C. § 119 of U.S. Provisional Application Ser. No .: 63/188,155 filed on May 13, 2021, the content of which is relied upon and incorporated herein by reference in its entirety.

### FIELD

The present disclosure relates generally to methods for manufacturing a glass ribbon and, more particularly, to methods for manufacturing a glass ribbon with a glass manufacturing apparatus comprising an enclosure.

### BACKGROUND

It is known to manufacture molten material into a glass ribbon with a glass manufacturing apparatus. The glass ribbon can pass from a forming apparatus to a destination. However, as the glass ribbon travels to the destination, particles in the air may adhere to a surface of the glass ribbon, reducing the quality of the glass ribbon.

### SUMMARY

The following presents a simplified summary of the disclosure to provide a basic understanding of some embodiments described in the detailed description.

In some embodiments, a glass manufacturing apparatus can comprise a forming apparatus that can form a glass ribbon and deliver the glass ribbon along a travel path. The glass manufacturing apparatus can comprise an enclosure that surrounds a portion of the travel path, such that the glass ribbon can pass through an interior of the enclosure. The glass manufacturing apparatus can comprise one or more gas sources that can deliver gas to the interior of the enclosure. By delivering the gas to the interior of the enclosure, the enclosure may be maintained at a first air pressure that is greater than a second air pressure at an exterior of the enclosure. The gas can travel from the interior of the enclosure through openings in the enclosure to an exterior (e.g., from high pressure to low pressure). This gas flow can shield the enclosure from materials within the surrounding air and limit the materials from entering the enclosure, thus reducing the likelihood of the materials contacting the glass ribbon as the glass ribbon travels within the enclosure.

In accordance with some embodiments, a glass manufacturing apparatus can comprise a forming apparatus configured to form a glass ribbon. The glass manufacturing apparatus can comprise an enclosure positioned downstream from the forming apparatus. The enclosure can comprise a first chamber, a first end defining an inlet opening of the first chamber, and a second end defining an outlet opening of the first chamber. A first enclosure wall of the enclosure can comprise an enclosure wall opening defining a gas travel path from the first chamber to an exterior of the enclosure. The glass manufacturing apparatus can comprise a ribbon travel path extending through the first chamber between the inlet opening and the outlet opening. The glass manufacturing apparatus can comprise a first conduit extending along a first side of the enclosure and comprising a second chamber, and a gas opening providing fluid communication between the first chamber and the second chamber. The glass manufacturing apparatus can comprise a first gas source in fluid communication with the second chamber. The first gas source can deliver a first gas to the first chamber through the second chamber.

In some embodiments, the first conduit can extend along a length of the enclosure. The gas opening can comprise a plurality of gas openings spaced along the length.

In some embodiments, the enclosure can comprise a plurality of rollers positioned within the first chamber and configured to support the glass ribbon in the enclosure.

In some embodiments, the gas opening can define a gas travel path from the second chamber to the first chamber. The gas travel path can extend between a first roller and a second roller of the plurality of rollers.

In some embodiments, the first roller can be rotatable about a first axis and the gas travel path can extend along a second axis substantially parallel to the first axis.

In some embodiments, a second conduit can extend along a second side of the enclosure and can define a third chamber.

In some embodiments, a second gas source may be in fluid communication with the third chamber. The second gas source can deliver a second gas to the first chamber through the second conduit.

In some embodiments, the first enclosure wall can comprise a first wall portion positioned adjacent to the inlet opening and configured to move between a first position, in which the first wall portion can cover an opening in the enclosure, and a second position, in which the opening is exposed.

In accordance with some embodiments, a glass manufacturing apparatus can comprise a forming apparatus that can form a glass ribbon. The glass manufacturing apparatus can comprise an enclosure positioned downstream from the forming apparatus. The enclosure can comprise a first chamber, a first end defining an inlet opening of the first chamber, and a second end defining an outlet opening of the first chamber. The enclosure can comprise a first enclosure wall comprising an enclosure wall opening defining a gas travel path from the first chamber to an exterior of the enclosure. The first enclosure wall can comprise a first wall portion that can move between a first position, in which the first wall portion covers an opening in the enclosure, and a second position, in which the opening is exposed. The glass manufacturing apparatus can comprise a ribbon travel path extending through the enclosure between the inlet opening and the outlet opening. The glass manufacturing apparatus can comprise a first conduit extending along a first side of the enclosure and comprising a second chamber. The first conduit can comprise a gas opening in fluid communication with the first chamber. The glass manufacturing apparatus can comprise a gas source that can deliver a first gas to the first chamber through the gas opening.

In some embodiments, the first conduit can extend along a length of the enclosure.

In some embodiments, the enclosure can comprise a plurality of rollers positioned within the first chamber and configured to support the glass ribbon in the enclosure.

In accordance with some embodiments, methods of manufacturing a glass ribbon can comprise forming a glass ribbon. The glass ribbon can descend vertically from a glass forming apparatus. Methods can comprise supporting the glass ribbon in a non-vertical orientation with a glass ribbon support apparatus comprising an enclosure defining a first chamber through which at least a portion of the glass ribbon travels in the non-vertical orientation. Methods can comprise directing a first gas into the first chamber from a first conduit extending along at least a portion of a length of the enclosure. The first conduit can comprise a second chamber. Methods can comprise flowing the first gas from the second chamber to the first chamber through at least one gas opening between the first chamber and the second chamber. Methods can comprise maintaining a pressure inside the first chamber greater than a pressure outside the enclosure.

In some embodiments, flowing the first gas can comprise flowing the first gas through a plurality of gas openings between the second chamber and the first chamber. The plurality of gas openings can be spaced apart along a length of the first conduit.

In some embodiments, the pressure inside the first chamber may be substantially constant along the length of the enclosure.

In some embodiments, methods can comprise moving a wall portion of the enclosure from a first position, in which the wall portion covers an opening in the enclosure, to a second position, in which the opening in the enclosure is exposed.

In some embodiments, maintaining the pressure inside the first chamber can comprise directing a portion of the first gas from the first chamber to an exterior of the first chamber.

In some embodiments, the portion of the first gas can be directed from the first chamber and through an inlet opening of the enclosure through which the glass ribbon enters the first chamber.

In some embodiments, the portion of the first gas can be directed from the first chamber and through an outlet opening of the enclosure through which the glass ribbon exits the first chamber.

In some embodiments, the portion of the first gas can be directed from the first chamber and through one or more enclosure wall openings in an enclosure wall of the enclosure.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates example embodiments of a glass manufacturing apparatus in accordance with embodiments of the disclosure;

FIG. 2 illustrates a side view of a support apparatus of the glass manufacturing apparatus in accordance with embodiments of the disclosure;

FIG. 3 illustrates sectional view of the support apparatus taken at lines 3-3 of FIG. 2 in accordance with embodiments of the disclosure;

FIG. 4 illustrates a perspective view of a portion of the support apparatus in accordance with embodiments of the disclosure;

FIG. 5 illustrates a side view of the glass ribbon entering the guide apparatus with a wall portion of the support apparatus in a closed first position in accordance with embodiments of the disclosure; and

FIG. 6 illustrates a side view of the glass ribbon entering the support apparatus with the wall portion of the support apparatus in an opened second position in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

The present disclosure relates to a glass manufacturing apparatus and methods for manufacturing a glass ribbon. For purposes of this application, “glass ribbon” may be considered one or more of a glass ribbon in a viscous state, a glass ribbon in an elastic state (e.g., at room temperature) and/or a glass ribbon in a viscoelastic state between the viscous state and the elastic state. Methods and apparatus for forming a glass ribbon will now be described by way of example embodiments. For purposes of the disclosure, in some embodiments, a glass manufacturing apparatus can comprise a glass forming apparatus that forms a glass article (e.g., a glass ribbon) from a quantity of molten material. In some embodiments, the glass ribbon can be employed in a variety of display applications comprising, but not limited to, liquid crystal displays (LCDs), electrophoretic displays (EPD), organic light emitting diode displays (OLEDs), plasma display panels (PDPs), touch sensors, photovoltaics, foldable phones, etc.

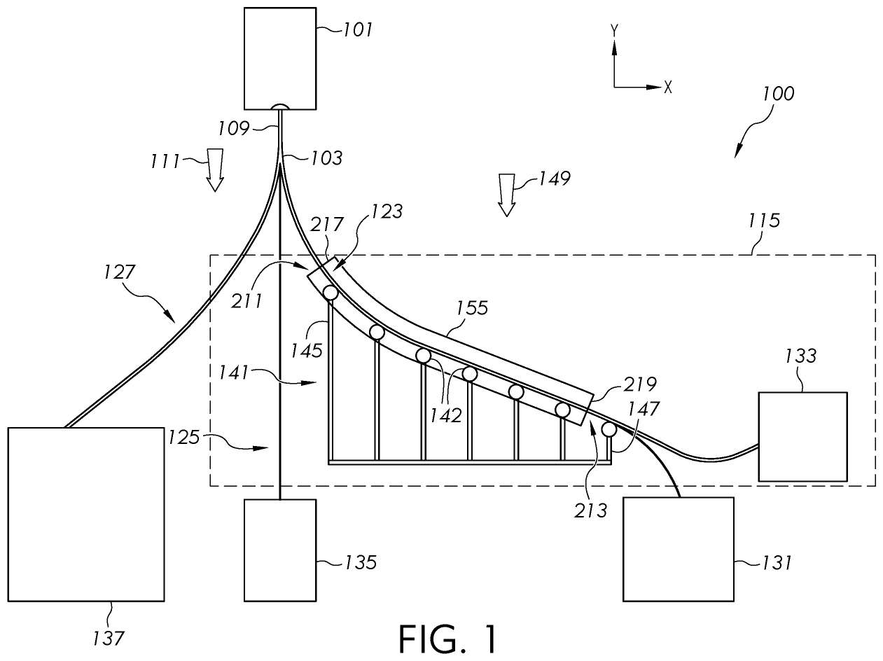

As schematically illustrated in FIG. 1, in some embodiments, an exemplary glass manufacturing apparatus 100 is shown comprising a forming apparatus 101 configured to form a glass ribbon 103. The forming apparatus 101 can comprise a slot draw apparatus, a float bath apparatus, a down-draw apparatus, an up-draw apparatus, a press-rolling apparatus, or any other glass forming apparatus that forms a glass ribbon.

The glass ribbon 103 exits the forming apparatus 101 and travels along a travel path 109 in a first travel direction 111. In some embodiments, the forming apparatus 101 can be positioned outside a clean room 115, with one or more portions of the glass manufacturing apparatus 100 positioned inside the clean room 115 (illustrated with dashed lines in FIG. 1) that can reduce the level of particulates (e.g., dust, airborne organisms, vaporized particles, etc.) inside the clean room compared to a level of particulates outside the clean room 115. The clean room 115 is maintained at a positive pressure relative to a pressure outside the clean room 115 such that air flows from inside the clean room 115 to the outside the clean room 115. In some embodiments, the pressure inside the clean room 115 may be about 5 pascals or more greater than the pressure outside the clean room 115. In some embodiments, the clean room 115 can comprise an ISO (“International Organization for Standardization”) 6 clean room, or better.

The glass ribbon 103 can enter the clean room 115 through an opening, for example, in a ceiling of the clean room 115. As the glass ribbon 103 enters the clean room 115, the glass ribbon 103 can be directed along one or more travel paths that extend into the clean room, for example, a first ribbon travel path 123, a second ribbon travel path 125, or a third ribbon travel path 127. In some embodiments, the glass ribbon 103 can be directed along the first ribbon travel path 123 to one or more alternate destinations, for example, a first destination 131, a second destination 133, etc. In some embodiments, glass ribbon 103 can be directed along the second ribbon travel path 125 to one or more alternate destinations, for example, a third destination 135. In some embodiments, glass ribbon 103 can be directed to move along the third ribbon travel path 127 to one or more alternate destinations, for example, a fourth destination 137. One or more of the destinations 131, 133, 135, 137 can comprise, for example, a disposal apparatus (e.g., wherein the glass ribbon 103 can be crushed within the disposal apparatus) or a winding apparatus (e.g., wherein the glass ribbon 103 can be wound into a roll on a spool).

In some embodiments, the glass ribbon 103 can be supported by a support apparatus 141 as the glass ribbon 103 travels along the first ribbon travel path 123 inside the clean room 115. In some embodiments, first ribbon travel path 123 can comprise a linearly extending travel path, although in further embodiments, the first ribbon travel path 123 can comprise a non-linearly extending travel path, for example, a curved travel path. In some embodiments, support apparatus 141 may comprise a plurality of rollers 142 arranged to support the glass ribbon 103 by contacting the glass ribbon as the glass ribbon moves along the first ribbon travel path 123 inside clean room 115.

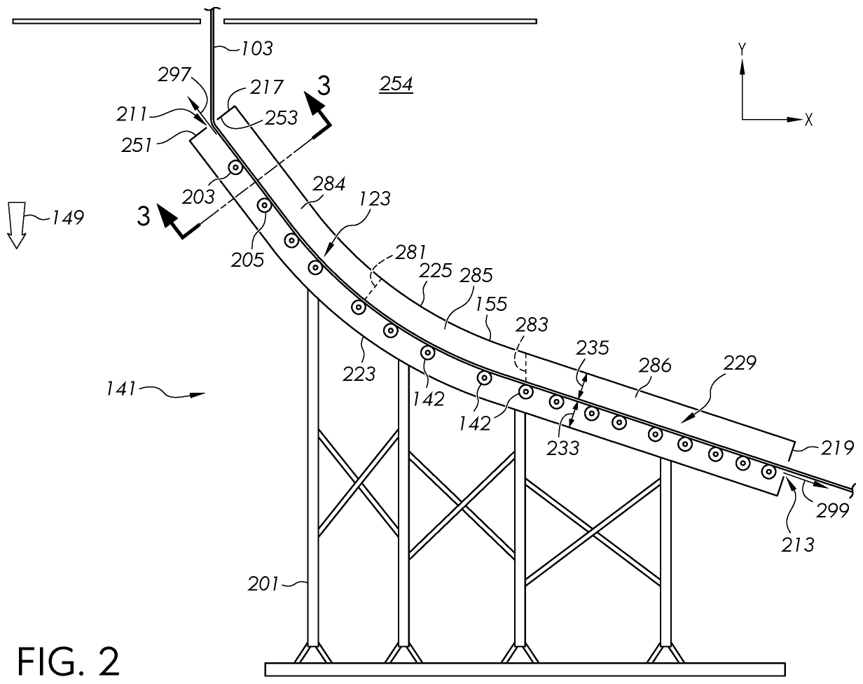

The support apparatus 141 extends between a first end 145 and a second end 147. The first end 145 may be located in proximity to and below the forming apparatus 101 such that the first end 145 initially receives the glass ribbon 103. In various embodiments, the first end 145 can be at a higher elevation than the second end 147. Accordingly, the first ribbon travel path 123 may be angled downwardly from the first end 145 toward the second end 147 such that, as the glass ribbon 103 travels along the first ribbon travel path 123, the glass ribbon 103 moves downwardly from the first end 145 toward the second end 147. For example, referring to FIG. 2, in some embodiments, the support apparatus 141 can comprise a support structure 201 supporting the plurality of rollers 142. The plurality of rollers 142 can be positioned at differing elevations. For example, a first roller 203 of the plurality of rollers 142 can be positioned at a first elevation and a second roller 205 of the plurality of rollers 142 can be positioned at a second elevation. In some embodiments, the first elevation and the second elevation may be different. For example, the second roller 205 may be at a lower elevation than the first roller 203. The support apparatus 141 can move the glass ribbon 103 from a substantially vertical orientation (e.g., at a location upstream from the support apparatus 141 that may be parallel to the direction of gravity 149) to a non-vertical orientation. Methods of manufacturing the glass ribbon 103 can comprise forming the glass ribbon 103 with the forming apparatus 101 such that the glass ribbon 103 descends vertically from the forming apparatus 101.

In some embodiments, the glass manufacturing apparatus 100 is not limited to comprising the plurality of rollers 142 for supporting and directing the glass ribbon 103. Rather, in some embodiments, the support apparatus 141 can comprise one or more contactless support apparatuses, for example, one or more air bearings. The air bearings can emit air toward the first ribbon travel path 123. Due to the impingement of the air on the glass ribbon from the air bearings, the air bearings can support the glass ribbon 103 without contacting the glass ribbon 103 (e.g., with the glass ribbon 103 spaced a distance apart from the air bearings). In some embodiments, a combination of the rollers 142 and air bearings can be used to support the glass ribbon 103, for example, with one or more air bearings and one or more rollers 142.

Referring to FIGS. 1-2, in various embodiments, the support apparatus 141 can comprise an enclosure 155 (e.g., a chute) that encloses at least a portion of first ribbon travel path 123 and a portion of the glass ribbon 103 as the glass ribbon 103 travels along the first ribbon travel path 123. The enclosure 155 is positioned downstream from the forming apparatus 101, and the plurality of rollers 142 can be positioned within the enclosure 155. For example, the first ribbon travel path 123 can extend through a first chamber 229 of the enclosure 155 between an inlet opening 211 at a first end 217 of the enclosure 155 and an outlet opening 213 at a second end 219 of the enclosure 155. The inlet opening 211 can comprise a slot through which the first ribbon travel path 123 and, thus, the glass ribbon 103, enters the enclosure 155. Similarly, the outlet opening 213 can comprise a slot through which the first ribbon travel path 123 and, thus, the glass ribbon 103, exits the enclosure 155. The plurality of rollers 142 are positioned within the first chamber 229 and can support the glass ribbon 103 within the enclosure 155. Methods of manufacturing the glass ribbon 103 can comprise supporting the glass ribbon 103 in a non-vertical orientation (e.g., that is non-parallel with the direction of gravity 149) with a glass ribbon support apparatus 141 comprising the enclosure 155 defining the first chamber 229 through which at least a portion of the glass ribbon 103 travels in the non-vertical orientation. The glass ribbon 103 can be supported in several ways, for example, with the one or more rollers 142, air bearings, etc.

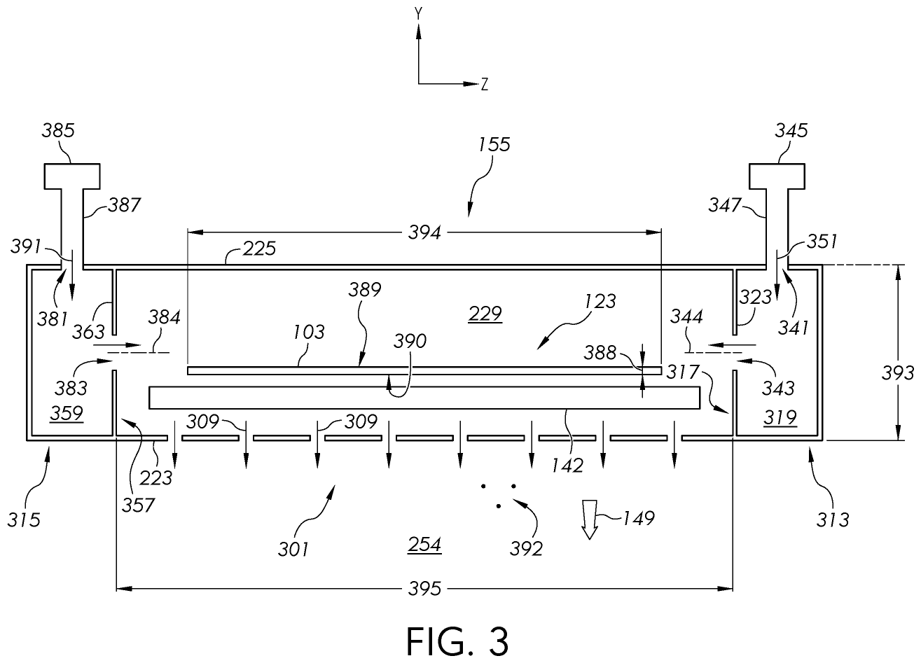

The enclosure 155 comprises one or more enclosure walls that form the first chamber 229. For example, in various embodiments, the enclosure 155 can have a rectangular cross-sectional shape in a plane orthogonal to the first ribbon travel path 123. Accordingly, and as shown in FIG. 2, the enclosure 155 can comprise a first, lower, enclosure wall 223 and a second, upper enclosure wall 225 spaced apart from the first enclosure wall 223. The plurality of rollers 142 are positioned between the first ribbon travel path 123 and the first enclosure wall 223, with the plurality of rollers 142 supporting the glass ribbon 103 as the glass ribbon 103 moves along the first ribbon travel path 123 within the enclosure 155. The enclosure 155 comprises the first chamber 229, with the first end 217 of the enclosure 155 defining the inlet opening 211 of the first chamber 229 and the second end 219 defining the outlet opening 213 of the first chamber 229. The first enclosure wall 223, the second enclosure wall 225, and the plurality of rollers 142 are arranged such that glass ribbon 103 does not contact the first enclosure wall 223 or the second enclosure wall 225 as the glass ribbon 103 travels along first ribbon travel path 123 through enclosure 155. That is, dimensions of the enclosure 155 are larger than dimensions of the glass ribbon 103. For example, in some embodiments, the glass ribbon 103 can comprise a thickness 388 between a first major surface 389 and a second major surface 390 of the glass ribbon 103 within a range from about 30 micrometers (e.g., microns) to about 300 microns, or within a range from about 30 microns to about 100 microns. In some embodiments, the enclosure 155 can comprise a height 393 (e.g., illustrated in FIG. 3) between the first enclosure wall 223 and the second enclosure wall 225 that may be within a range from about 150 millimeters to about 450 millimeters or be within a range from about 200 millimeters to about 400 millimeters, or about 300 millimeters. In some embodiments, the glass ribbon 103 can comprise a width 394 (e.g., illustrated in FIG. 3) that may be within a range from about 300 millimeters to about 600 millimeters. In some embodiments, the first chamber 229 of the enclosure 155 can comprise a width 395 (e.g., between a second conduit wall 323 and a fourth conduit wall 363) that may be within a range from about 700 millimeters to about 900 millimeters.

The inlet opening 211 may be smaller in size (e.g., between the first end wall 251 and the second end wall 253) than the first chamber 229 (e.g., a sum of the first distance 233 and the second distance 235 separating the first enclosure wall 223 and the second enclosure wall 225). By providing the inlet opening 211 with a reduced size compared to the first chamber 229, the inlet opening 211 can restrict a flow of particles and/or air from outside the enclosure 155 to an interior (e.g., the first chamber 229) of the enclosure 155 through the inlet opening 211. Similarly, the outlet opening 213 may be smaller in size than the first chamber 229 (e.g., a sum of the first distance 233 and the second distance 235 separating the first enclosure wall 223 and the second enclosure wall 225). By providing the outlet opening 213 with a reduced size compared to the first chamber 229, the outlet opening 213 may restrict a flow of particles and/or air from outside the enclosure 155 to the interior (e.g., the first chamber 229) of the enclosure 155 through the outlet opening 213.

FIG. 3 illustrates a cross-sectional view of the enclosure 155 viewed from the perspective indicated by lines 3-3 of FIG. 2. As shown, the first enclosure wall 223 can comprise one or more enclosure wall openings 301. The one or more enclosure wall openings 301 provide a gas travel path 309 from the first chamber 229 to the exterior 254 of the enclosure 155. In some embodiments, the second enclosure wall 225 may not comprise any openings and may comprise a substantially continuous material such that air, gas, particles, etc., are prevented from passing through second enclosure wall 225. Additional enclosure wall openings (e.g., that may be substantially similar to the enclosure wall openings 301) may be spaced apart along the length of the first enclosure wall 223 between the first end 217 and the second end 219 of the enclosure 155. However, in further embodiments, second enclosure wall 225 can comprise one or more enclosure wall openings, and in still further embodiments, both first and second enclosure walls may include enclosure wall openings.

Still referring to FIG. 3, the support apparatus 141 further comprises one or more conduits that deliver a gas, for example air, to the first chamber 229. For example, the support apparatus 141 can comprise a first conduit 313 extending along a first side 317 of the enclosure 155, the first conduit 313 defining a second chamber 319 therein. In some embodiments, the first conduit 313 can be attached to the enclosure 155, e.g., by welding or mechanical fasteners, such that the first conduit 313 may be in a fixed and non-movable position relative to the enclosure 155. By being fixed and non-movable, the first conduit 313 (e.g., and an opposing second conduit) can define a fixed lateral feed conduit that extends along the first side 317 of the first chamber 229.

The first conduit 313 is in fluid communication with a first gas source 345, for example through a first gas tube 347, wherein a first gas 351 can be delivered from the first gas source 345 through the first gas tube 347, and into the first conduit 313 (and the second chamber 319) through a first gas opening 341. A second gas opening 343 provides fluid communication between the first chamber 229 and the second chamber 319. For example, the second gas opening 343 can define a gas travel path from the second chamber 319 to the first chamber 229 such that the first gas 351 can travel from the second chamber 319, through the second gas opening 343, and into the first chamber 229. In some embodiments, the first conduit 313 may share a common wall with enclosure 155, wherein the second gas opening 343 is a passage through the common wall. However, in further embodiments, the first conduit 313 can be joined to the enclosure 155 by a duct, a pipe, or other hollow structure, wherein the hollow interior of the duct or pipe forms the second gas opening 343 into the first chamber 229. In these embodiments, the first conduit 313 comprises a gas opening (e.g., the second gas opening 343) that is in fluid communication with the first chamber 229.

The first gas source 345 is in fluid communication with the second chamber 319 such that, in some embodiments, the first gas source 345 delivers the first gas 351, for example, as a compressed gas, to the first chamber 229 through the second chamber 319. The first gas source 345 can deliver the first gas 351 to the first chamber 229 through the second gas opening 343. In some embodiments, the second chamber 319 may be maintained at a higher pressure than the first chamber 229. Gas delivered to the first chamber 229 (e.g., from the gas source(s)) can comprise a clean gas that may be free of particulates such that the first chamber 229 can be maintained as an ISO 1 or an ISO 2 clean room environment. As used herein, a gas source (e.g., 345, 385) can comprise a structure that can supply air, for example, a fan, a blower, a pump, a tank of compressed air, etc. Methods of manufacturing the glass ribbon 103 can comprise directing the first gas 351 into the first chamber 229 from the first conduit 313 extending along at least a portion of a length of the enclosure 155, the first conduit 313 comprising the second chamber 319. Methods can comprise flowing the first gas 351 from the second chamber 319 to the first chamber 229 through at least one gas opening, for example, the second gas opening 343, between the first chamber 229 and the second chamber 319.

In some embodiments, the one or more conduits can comprise a second conduit 315 extending along a second side 357 of the enclosure 155, the second conduit 315 defining a third chamber 359 therein. The second conduit 315 can be arranged oppositely to first conduit 313. The second conduit 315 can be configured substantially the same as first conduit 313. Accordingly, third chamber 359 can be in fluid communication with a second gas source 385, for example through a second gas tube 387 extending between the first gas source and the second conduit 315, the second gas tube 387 forming a third gas opening 381 into third chamber 359. Third chamber 359 is in fluid communication with first chamber 229 through a fourth gas opening 383. In some embodiments, second conduit 315 may share a common wall with enclosure 155, wherein fourth gas opening 383 is a passage through the common wall. However, in further embodiments, second conduit 315 can be joined to enclosure 155 by a duct, a pipe, or other hollow structure, wherein the hollow interior of the duct or pipe forms the fourth gas opening 383 into first chamber 229.

In some embodiments, the second gas opening 343 and the fourth gas opening 383 can be arranged to direct the gas at different elevations relative to the glass ribbon 103. For example, a first gas opening axis 344 can extend through a center of the second gas opening 343 and a second gas opening axis 384 can extend through a center of the fourth gas opening 383. In some embodiments, the first gas opening axis 344 and the second gas opening axis 384 may be parallel, with the first gas opening axis 344 and the second gas opening axis 384 substantially perpendicular to the direction of gravity 149. In some embodiments, the first gas opening axis 344 and the second gas opening axis 384 may be colinear such that the second gas opening 343 and the fourth gas opening 383 may be at the same elevation, or distance from the first enclosure wall 223 along the direction of gravity 149. In some embodiments, the first gas opening axis 344 and the second gas opening axis 384 may not be collinear, for example, with the second gas opening 343 and the fourth gas opening 383 at different elevations, or distances from the first enclosure wall 223 along the direction of gravity 149. For example, in some embodiments, one of the gas openings (e.g., the second gas opening 343) may be above the glass ribbon 103 such that the first gas opening axis 344 is above the glass ribbon 103, and the other of the gas openings (e.g., the fourth gas opening 383) may be below the glass ribbon 103 such that the second gas opening axis 384 may be below the glass ribbon 103. As such, by directing the gas above the glass ribbon 103 (e.g., from the second gas opening 343) and below the glass ribbon 103 (e.g., from the fourth gas opening 383), the travel paths of the gas may not interfere such that a more consistent gas flow above and below the glass ribbon 103 may be achieved. In some embodiments, the second gas opening 343 and/or the fourth gas opening 383 can comprise a plurality of openings positioned along a length (e.g., substantially the entire length) of the enclosure 155. In further embodiments, the second gas opening 343 and/or the fourth gas opening 383 can comprise one or more continuous slots extending along the length (e.g., substantially the entire length) of the enclosure 155.

The second gas source 385 can deliver a second gas 391 as a compressed gas to the third chamber 359. In some embodiments, the third chamber 359 may be maintained at a higher pressure than the first chamber 229. As shown in FIG. 3, the second conduit 315 can be spaced apart from the first conduit 313 with the first chamber 229 positioned between the first conduit 313 and the second conduit 315. As such, the first chamber 229 can receive gas (e.g., 351, 391) from opposing sides of the enclosure 155, for example, from the first side 317 and the second side 357. By positioning the first conduit 313 and the second conduit 315 on opposing sides of the enclosure 155, a more consistent flow of gas into the first chamber 229 can be achieved. Both sides 317, 357 of the enclosure 155 may therefore be maintained at a substantially equal air pressure, reducing air pressure variations within the first chamber 229. By reducing air pressure variations within the first chamber 229, a more consistent gas flow along the gas travel paths 309 through the enclosure wall openings 301 may be achieved.

Methods of manufacturing the glass ribbon 103 can comprise delivering a gas (e.g., the gas 351, 391) to the first chamber 229 through a gas opening (e.g., the third gas opening 381 or the fourth gas opening 383). For example, the gas may be supplied from one or more gas sources though one or more conduits (e.g., the first conduit 313 or the second conduit 315) arranged in fluid communication with the first chamber. Methods can further comprise directing a portion of the gas from the first chamber 229 to an exterior of the enclosure 155 openings (e.g., 301) in a wall of the enclosure (e.g., first enclosure wall 223). The first chamber 229 can be maintained at a first air pressure greater than a second air pressure outside the enclosure. As a result of this differential air pressure, a portion of the gas 351, 391 flows from the first chamber 229 and to the exterior 254 through the enclosure wall openings 301. Accordingly, the glass ribbon 103 can be shielded from a material 392 (e.g., contaminant) outside the enclosure 155 that may otherwise contaminate the glass ribbon 103. In some embodiments, the material 392 can comprise one or more of a liquid, a solid, or a gas. In some embodiments, the material 392 can comprise a by-product of the glass manufacturing process and/or materials that may be present in the air at the exterior 254, for example, dust, particles of airborne glass, etc. In some embodiments, the material 392 can comprise particles with sizes that may be within a range from less than about 1 micrometer to about 500 micrometers. If the material 392 contacts the glass ribbon 103, then the quality of the glass ribbon 103 may be reduced. As such, avoiding contact between the material 392 and the glass ribbon 103 can reduce the likelihood of a reduction in quality of the glass ribbon 103. The gas exiting the enclosure wall openings 301 can exert a force on the material 392 and direct the material 392 away from the enclosure 155. As such, the exiting gas can shield the first chamber 229 of the enclosure 155 from the material 392 and reduce the likelihood of the material 392 entering the enclosure 155 and contacting the glass ribbon 103.

In some embodiments, the support apparatus 141 can comprise a gas vacuum pump that can remove gas from the first chamber 229 such that one or more of the first gas source 345 or the second gas source 385 can be replaced with a gas vacuum pump. For example, in some embodiments, the first conduit 313 can deliver the gas (e.g., from the first gas source 345) to the first chamber 229 while the second conduit 315 can remove gas (e.g., via a vacuum pump) from the first chamber 229. A vacuum pump can comprise an apparatus that draws gas out of a volume (e.g., the first chamber 229). By simultaneously supplying gas to the first chamber 229 and removing gas from the first chamber 229, the likelihood of the material 392 entering the first chamber 229 and contacting the glass ribbon 103 may be reduced. For example, the first chamber 229 can be maintained at a positive pressure relative to the exterior 254 such that the gas (e.g., from the first gas source 345) may exit the first chamber 229 through the enclosure wall openings 301. Simultaneously, the vacuum (e.g., applied to second chamber 319 removes air from the first chamber 229 (e.g., through the third gas opening 381 and the fourth gas opening 383). As such, any material 392 that may be present within the first chamber 229 can be removed by the vacuum while the gas flow through the enclosure wall openings 301 limit any material 392 from entering the first chamber 229. In embodiments in which the glass manufacturing apparatus 100 comprises one or more gas sources and zero vacuums, and embodiments in which the glass manufacturing apparatus 100 comprises one or more gas sources and one or more vacuums, the first chamber 229 may be maintained at a positive pressure relative to the exterior 254 such that methods can comprise maintaining the pressure inside the first chamber 229 greater than a pressure outside the enclosure 155 at the exterior 254. For example, maintaining the pressure inside the first chamber 229 can comprise directing a portion of the first gas 351 from the first chamber 229 to the exterior 254 of the first chamber 229.

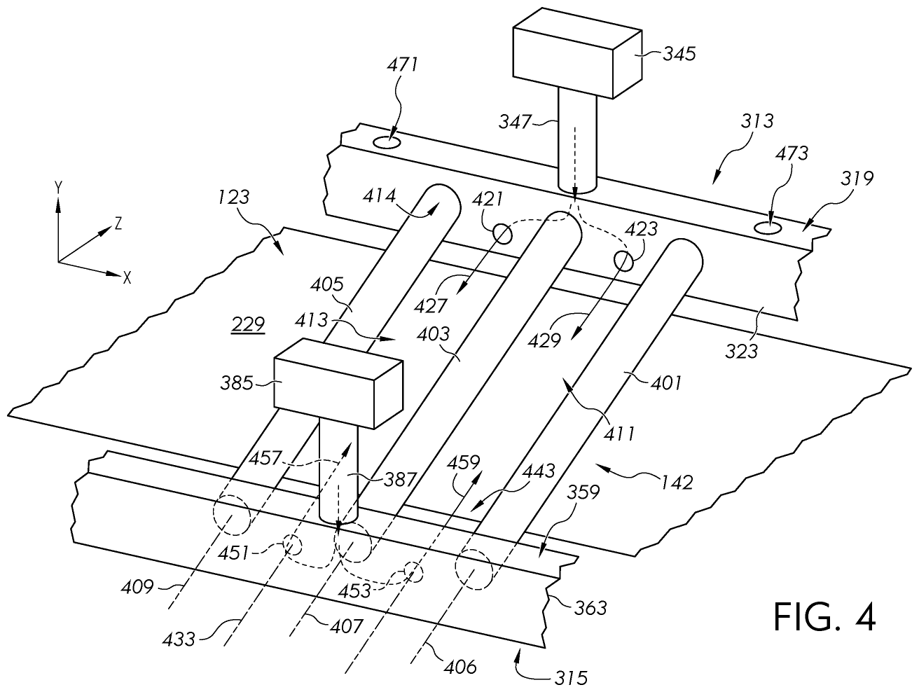

Referring to FIG. 4, a perspective view of a portion of the support apparatus 141 is illustrated. For example, the portion of the support apparatus 141 illustrated in FIG. 4 comprises the first conduit 313, the second conduit 315, and some of the rollers 142. In some embodiments, the rollers 142 can comprise a first roller 401, a second roller 403, and a third roller 405. The first roller 401, the second roller 403, and the third roller 405 may be substantially identical in structure and function to the rollers 203, 205 illustrated in FIG. 2. For example, the first roller 401, the second roller 403, and the third roller 405 arranged along a portion of the first ribbon travel path 123 along which the glass ribbon 103 travels. In some embodiments, the rollers 401, 403, 405 can be arranged to extend between the first conduit 313 and the second conduit 315. For example, the first roller 401 can extend along and is rotatable about a first roller axis 406, the second roller 403 can extend along and is rotatable about a second roller axis 407, and the third roller 405 can extend along and is rotatable about a third roller axis 409. In some embodiments, the first roller axis 406, the second roller axis 407, and the third roller axis 409 can be substantially parallel to each other, with the first roller axis 406, the second roller axis 407, and the third roller axis 409 intersecting the first conduit 313 and the second conduit 315. In some embodiments, the first roller 401 and the second roller 403 can be spaced apart to define a first space 411 between the first roller 401 and the second roller 403. In some embodiments, the second roller 403 and the third roller 405 can be spaced apart to define a second space 413 between the second roller 403 and the third roller 405.

In some embodiments, the first conduit 313 and the second conduit 315 can be arranged to deliver the gas to the first space 411 and the second space 413. For example, the first conduit 313 can comprise a plurality of gas openings 414 that may be in fluid communication with the first chamber 229 and may be spaced along the length of the enclosure 155. In some embodiments, the plurality of gas openings 414 can comprise a first gas opening 421 and a second gas opening 423. The gas openings 421, 423 can provide gas travel paths from the second chamber 319 to the first chamber 229. For example, the first gas opening 421 can provide a first gas travel path 427 from the second chamber 319 to the first chamber 229 and the second gas opening 423 can define a second gas travel path 429 from the second chamber 319 to the first chamber 229. In some embodiments, the first gas travel path 427 can extend through the second space 413 along a gas axis 433 that may be substantially parallel to one or more of the first roller axis 406, the second roller axis 407, or the third roller axis 409. In some embodiments, the second gas travel path 429 can extend into the first space 411 between the first roller 401 and the second roller 403 of the plurality of rollers 142. In some embodiments, methods can comprise flowing the first gas 351 through the plurality of plurality of gas openings 414 between the second chamber 319 and the first chamber 229, with the plurality of gas openings 414 spaced apart along a length of the first conduit 313.

The second conduit 315 may comprise a plurality of gas openings 443 that may be substantially similar in arrangement and function to the plurality of gas openings 414 of the first conduit 313. For example, the second conduit 315 can comprise the plurality of gas openings 443 in fluid communication with the first chamber 229. The plurality of gas openings 443 can comprise a third gas opening 451 and a fourth gas opening 453. The gas openings 451, 453 provide gas travel paths from the third chamber 359 to the first chamber 229. For example, the third gas opening 451 can define a third gas travel path 457 from the third chamber 359 to the first chamber 229 and the fourth gas opening 453 can define a fourth gas travel path 459 from the third chamber 359 to the first chamber 229. In some embodiments, the third gas travel path 457 may be into the second space 413 between the second roller 403 and the third roller 405. In some embodiments, the fourth gas travel path 459 may be into the first space 411 between the first roller 401 and the second roller 403.

While only a portion of the first conduit 313 and the second conduit 315 are illustrated in FIG. 4, in some embodiments, the first conduit 313 and the second conduit 315 can extend along a length of the enclosure 155 (e.g., illustrated in FIGS. 1-3) between the first end 217 and the second end 219. The first conduit 313 and the second conduit 315 can comprise the plurality of gas openings 414, 443 arranged similarly to the gas openings illustrated in FIGS. 3-4. For example, the plurality of gas openings 414 of the first conduit 313 may be arranged between some or all of the plurality of rollers 142 along the first side 317 of the enclosure 155. Similarly, the plurality of gas openings 443 of the second conduit 315 may be arranged between some or all of the plurality of rollers 142 along the second side 357 of the enclosure 155. By arranging the plurality of spaced apart gas openings 414, 443 between the plurality of rollers 142 on opposing sides 317, 357 of the enclosure 155, a more consistent flow of gas into the first chamber 229 along a length of the enclosure 155 can be achieved. In addition, by arranging the plurality of gas openings 414, 443 in the spaces 411, 413 between rollers 401, 403, 405, the rollers 401, 403, 405 may not impede or block the flow of the gas through the plurality of gas openings 414, 443 and into the first chamber 229, thus providing a substantially consistent flow rate of gas through each of the plurality of gas openings 414, 443. As such, the pressure inside the first chamber 229 may be substantially constant along the length of the enclosure 155 which reduces the likelihood of air pressure variations within the first chamber 229.

In some embodiments, the one or more gas sources 345, 385 may supply the gas to the first conduit 313 and the second conduit 315. For example, the first conduit 313 illustrated in FIG. 4 is supplied with gas from the first gas source 345, and the second conduit 315 illustrated in FIG. 4 is supplied with gas from the second gas source 385. Accordingly, in some embodiments, one gas source may deliver gas to one conduit. However, in some embodiments, a plurality of gas sources may deliver gas to one conduit. For example, the first conduit 313 may receive gas from a plurality of gas sources such that the plurality of gas sources can deliver gas to the first conduit 313 at different locations along the length of the first conduit 313. For example, in addition to the first gas source 345 delivering the gas through the first gas tube 347 to the first gas opening 341, other gas sources can deliver gas through a second gas opening 471 or a third gas opening 473, wherein the second gas opening 471 and the third gas opening 473 may be spaced apart along the length of the first conduit 313. As such, delivering the gas can comprise delivering the gas through a plurality of gas openings (e.g., 341, 471, 473, etc.) in and spaced apart along a length of the first conduit 313 between the first end 217 and the second end 219 of the enclosure 155. By delivering gas from a plurality of gas sources to the first conduit 313 at differing locations, a more consistent flow of gas into the second chamber 319 and a more even air pressure along the length of the first conduit 313 may be achieved. Similarly, the second conduit 315 may be supplied by multiple gas sources and multiple gas openings along a length of the second conduit, with similar results.

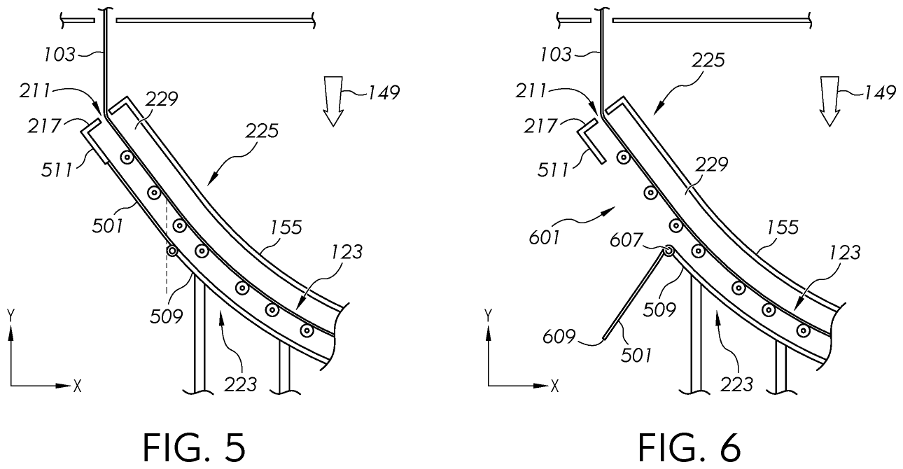

Referring to FIGS. 5-6, a side view of the support apparatus 141 at the first end 217 of the enclosure 155 is illustrated. In some embodiments, the first enclosure wall 223 may comprise a single wall portion extending along the length of the enclosure 155 between the first end 217 and the second end 219, such that the first enclosure wall 223 may be formed as a single piece. However, in some embodiments, the first enclosure wall 223 may comprise a plurality of wall portions arranged to extend along the length of the enclosure 155 between the first end 217 and the second end 219. In some embodiments, the first enclosure wall 223 can comprise a first wall portion 501 that may be positioned adjacent to the inlet opening 211. The first wall portion 501 can move (e.g., pivot) between a first position (e.g., illustrated in FIG. 5), in which the first wall portion 501 covers an opening 601 in the enclosure 155, and a second position (e.g., illustrated in FIG. 6), in the opening 601 is exposed. In some embodiments, the first wall portion 501 may be positioned between a second wall portion 509 and a third wall portion 511, with the second wall portion 509 and the third wall portion 511 positioned along the bottom of the enclosure 155. For example, moving from the first end 217 to the second end 219 of the enclosure 155, the third wall portion 511 may be located in closest proximity to the first end 217, followed by the first wall portion 501, followed by the second wall portion 509.

In some embodiments, the second wall portion 509 can be attached to the first wall portion 501 such that the first wall portion 501 and the second wall portion 509 can extend along a side of the first chamber 229 when the first wall portion 501 is in the first position. For example, as illustrated in FIG. 6, the first wall portion 501 can extend between a first wall end 607 and a second wall end 609. In some embodiments, the first wall end 607 can be attached to the second wall portion 509 such that the first wall end 607 can pivot relative to the second wall portion 509 as the first wall portion 501 moves between the first position and the second position. In some embodiments, the first wall end 607 can be pivotably attached to the second wall portion 509 (e.g., by a hinge or other type of mechanical fastener that facilitates movement). In some embodiments, the second wall end 609 can be attach to the third wall portion 511 when the first wall portion 501 is in the first position (e.g., illustrated in FIG. 5). For example, the second wall end 609 can be attached to the third wall portion 511 by mechanical fasteners (e.g., screws, bolts, adhesives, locking structures, etc.) such that the second wall end 609 can be selectively attached to and detached from the third wall portion 511. In some embodiments, when the second wall end 609 is attached to the third wall portion 511, the first wall portion 501 may remain in the first position and may be prevented from inadvertently moving to the second position. In some embodiments, when the second wall end 609 is detached from the third wall portion 511, the first wall portion 501 can move (e.g., pivot, rotate, etc.) from the first position to the second position.

During operation of the glass manufacturing apparatus 100, the glass ribbon 103 enters the inlet opening 211 and travels along the first ribbon travel path 123 within the first chamber 229. Methods can comprise moving a wall portion (e.g., the first wall portion 501) of the first enclosure wall 223 from the first position, in which the first wall portion 501 covers the opening 601 in the enclosure 155, to the second position, in which the opening 601 in the enclosure 155 is exposed, providing access to the first chamber 229 through the opening 601 for maintenance, cleaning, inspection, etc. of the first chamber 229. In some embodiments, the first wall portion 501 can be moved to the second position as the glass ribbon 103 moves along the first ribbon travel path 123 within the first chamber 229 such that access to the first chamber 229 can be achieved with or without stopping production and/or movement of the glass ribbon 103. In some embodiments, after opening and closing the first wall portion 501, a sensor (e.g., an airborne particle counter) can detect the cleanliness of the air within the first chamber 229 to ensure first chamber 229 is within a predetermined standard for cleanliness. As such, improvements in efficiency can be achieved due to this access. While the first enclosure wall 223 is illustrated as comprising one wall portion (e.g., the first wall portion 501) that moves between the first position and the second position, in some embodiments, the first enclosure wall 223 can comprise a plurality of wall portions that may move between a first, closed position and a second, open, position to provide access to the first chamber 229. The plurality of movable wall portions can be located at different locations along the enclosure 155 such that different locations of the first chamber 229 can be accessed. In some embodiments, the second enclosure wall 225 can comprise one or more movable wall portions (e.g., similar to the first wall portion 501) such that the first chamber 229 can be accessed at one or more locations through the second enclosure wall 225.

Enclosure wall openings 301 in the first enclosure wall 223 can allow for directing a portion of the gas from the first chamber 229 to the exterior 254 of the enclosure 155. In some embodiments, directing a portion of the gas can comprise directing a second portion 297 of the gas through the inlet opening 211 of the enclosure 155 through which the glass ribbon 103 enters the first chamber 229. The inlet opening 211 is larger (e.g., in width and thickness) than the glass ribbon 103 to allow the glass ribbon 103 to enter the first chamber 229 without contacting the first end wall 251 and/or the second end wall 253 that border the inlet opening 211. As such, to limit the likelihood of unwanted materials (e.g., the material 392 of FIG. 3) entering the first chamber 229 through the inlet opening 211, the second portion 297 of the gas may be directed through the inlet opening 211 from the first chamber 229 to the exterior 254.

For example, as previously described, the first chamber 229 can be maintained at the first air pressure greater than the second air pressure outside the enclosure.

Accordingly, the second portion 297 of the gas travels from the first chamber 229, through the inlet opening 211, and to the exterior 254. As such, the second portion 297 of the gas can shield the first chamber 229 from unwanted materials by exerting a force on the materials away from the inlet opening 211. Similarly, in some embodiments, directing a portion of the gas can comprise directing a third portion 299 of the gas through the outlet opening 213 of the enclosure 155 through which the glass ribbon 103 exits the first chamber 229. The outlet opening 213 is larger (e.g., in width and thickness) than the glass ribbon 103 to allow the glass ribbon 103 to exit the first chamber 229 without contacting the enclosure at the outlet opening. To limit the likelihood of unwanted materials entering the first chamber 229 through the outlet opening 213, the third portion 299 of the gas may be directed through the outlet opening 213 from the first chamber 229 to the exterior 254. Thus, the third portion 299 of the gas may shield the first chamber 229 from unwanted materials by exerting a force away from the outlet opening 213.

In some embodiments, the enclosure 155 can be separated into a plurality of zones. For example, referring to FIG. 2, one or more baffle walls can extend from an interior surface of the second enclosure wall 225 toward the first enclosure wall 223. For example, the enclosure 155 can comprise a first baffle wall 281 and a second baffle wall 283 spaced apart from the first baffle wall. The first baffle wall 281 and the second baffle wall 283 can extend toward the first ribbon travel path 123 but are spaced apart from the first ribbon travel path 123 to avoid contacting the glass ribbon 103. In some embodiments, a first zone 284 may be defined between the first end 217 and the first baffle wall 281, a second zone 285 may be defined between the first baffle wall 281 and the second baffle wall 283, and a third zone 286 may be defined between the second baffle wall 283 and the second end 219. In some embodiments, the zones 284, 285, 286 may be maintained at the same air pressure or at different air pressures. For example, gas may be supplied to each of the zones 284, 285, 286, such that the zones 284, 285, 286 may be maintained at a positive pressure that is greater than the second air pressure outside the enclosure 155. Accordingly, the zones 284, 285, 286 can provide a more even gas distribution, and consistent positive pressure, along the length of the enclosure 155 to reduce the likelihood of materials 392 entering the enclosure 155 through an opening thereof.

In some embodiments, the exterior environment 254 may be located within the clean room 115, which can comprise up to an ISO 6 clean room. Maintaining the first chamber 229 at a positive pressure as compared to the exterior 254, the first chamber 229 can comprise an even higher clean room environment, for example, an ISO 1 or an ISO 2 clean room. By providing gas to the first chamber 229 through a plurality of gas sources (e.g., from the gas sources 345, 385, etc.) and shielding the first chamber 229 from contaminating material outside the enclosure 155, the glass ribbon 103 can be maintained in a clean environment substantially void of the materials 392. Due to the reduced volume of the enclosure 155 (e.g., as compared to the clean room size), a reduced amount of gas is supplied to the first chamber 229 compared to the amount of gas that would be supplied to maintain the room at the same cleanliness standard as the first chamber 229. As such, the enclosure 155 may provide a more efficient and cost-effective environment within which the glass ribbon 103 can travel while limiting contamination of the glass ribbon 103 from the materials 392.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, another embodiment includes from the one value to the other value. Similarly, when values are expressed as approximations by use of the antecedent “about,” it will be understood that the value forms another embodiment. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Modifications may be made to the instant disclosure without departing from the scope or spirit of the claimed subject matter. Unless specified otherwise, “first.” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different or two identical ends or the same end

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a forming apparatus configured to form a glass ribbon:
an enclosure positioned downstream from the forming apparatus, the enclosure comprising a first chamber, a first end defining an inlet opening of the first chamber, and a second end defining an outlet opening of the first chamber, a first enclosure wall of the enclosure comprising an enclosure wall opening defining a gas travel path from the first chamber to an exterior of the enclosure:
a ribbon travel path extending through the first chamber between the inlet opening and the outlet opening:
a first conduit extending along a first side of the enclosure and comprising a second chamber, and a gas opening providing fluid communication between the first chamber and the second chamber; and
a first gas source in fluid communication with the second chamber, the first gas source configured to deliver a first gas to the first chamber through the second chamber.

2. The glass manufacturing apparatus of claim 1, wherein the first conduit extends along a length of the enclosure, the gas opening comprising a plurality of gas openings spaced along the length.

3. The glass manufacturing apparatus of claim 2, wherein the enclosure comprises a plurality of rollers positioned within the first chamber and configured to support the glass ribbon in the enclosure.

4. The glass manufacturing apparatus of claim 3, wherein the gas opening defines a gas travel path from the second chamber to the first chamber, the gas travel path extending between a first roller and a second roller of the plurality of rollers.

5. The glass manufacturing apparatus of claim 4, wherein the first roller is rotatable about a first axis and the gas travel path extends along a second axis substantially parallel to the first axis.

6. The glass manufacturing apparatus of claim 1, further comprising a second conduit extending along a second side of the enclosure and defining a third chamber.

7. The glass manufacturing apparatus of claim 6, further comprising a second gas source in fluid communication with the third chamber, the second gas source configured to deliver a second gas to the first chamber through the second conduit.

8. The glass manufacturing apparatus of claim 1, wherein the first enclosure wall comprises a first wall portion positioned adjacent to the inlet opening and configured to move between a first position, in which the first wall portion covers an opening in the enclosure, and a second position, in which the opening is exposed.

9. A glass manufacturing apparatus comprising:
a forming apparatus configured to form a glass ribbon:
an enclosure positioned downstream from the forming apparatus, the enclosure comprising a first chamber, a first end defining an inlet opening of the first chamber, and a second end defining an outlet opening of the first chamber, the enclosure further comprising a first enclosure wall comprising an enclosure wall opening defining a gas travel path from the first chamber to an exterior of the enclosure, the first enclosure wall comprising a first wall portion configured to move between a first position, in which the first wall portion covers an opening in the enclosure, and a second position, in which the opening is exposed:
a ribbon travel path extending through the enclosure between the inlet opening and the outlet opening:
a first conduit extending along a first side of the enclosure and comprising a second chamber, the first conduit comprising a gas opening in fluid communication with the first chamber; and
a gas source configured to deliver a first gas to the first chamber through the gas opening.

10. The glass manufacturing apparatus of claim 9, wherein the first conduit extends along a length of the enclosure.

11. The glass manufacturing apparatus of claim 10, wherein the enclosure comprises a plurality of rollers positioned within the first chamber and configured to support the glass ribbon in the enclosure.

12. A method of manufacturing a glass ribbon, comprising:
forming a glass ribbon, the glass ribbon descending vertically from a glass forming apparatus:
supporting the glass ribbon in a non-vertical orientation with a glass ribbon support apparatus comprising an enclosure defining a first chamber through which at least a portion of the glass ribbon travels in the non-vertical orientation:
directing a first gas into the first chamber from a first conduit extending along at least a portion of a length of the enclosure, the first conduit comprising a second chamber:
flowing the first gas from the second chamber to the first chamber through at least one gas opening between the first chamber and the second chamber; and
maintaining a pressure inside the first chamber greater than a pressure outside the enclosure.

13. The method of claim 12, wherein the flowing the first gas comprises flowing the first gas through a plurality of gas openings between the second chamber and the first chamber, the plurality of gas openings spaced apart along a length of the first conduit.

14. The method of claim 12, wherein the pressure inside the first chamber is substantially constant along the length of the enclosure.

15. The method of claim 12, further comprising moving a wall portion of the enclosure from a first position, in which the wall portion covers an opening in the enclosure, to a second position, in which the opening in the enclosure is exposed.

16. The method of claim 12, wherein the maintaining the pressure inside the first chamber comprises directing a portion of the first gas from the first chamber to an exterior of the first chamber.

17. The method of claim 16, wherein the portion of the first gas is directed from the first chamber and through an inlet opening of the enclosure through which the glass ribbon enters the first chamber.

18. The method of claim 16, wherein the portion of the first gas is directed from the first chamber and through an outlet opening of the enclosure through which the glass ribbon exits the first chamber.

19. The method of claim 16, wherein the portion of the first gas is directed from the first chamber and through one or more enclosure wall openings in an enclosure wall of the enclosure.
